(19) United States
(12) Patent Application Publication
(10) Pub. No.: US 2018/0319982 A1
(43) Pub. Date: Nov. 8, 2018

(54) METHOD FOR THE MANUFACTURE OF (PER)FLUOROPOLYETHER MODIFIED POLYAMIDES AND POLYAMIDES OBTAINABLE WITH SUCH METHOD

(71) Applicant: SOLVAY SPECIALTY POLYMERS ITALY S.P.A., Bollate MI (IT)

(72) Inventors: Claudio Adolfo Pietro TONELLI, Paderno D'Adda (IT); Ritu AHUJA, Vadodara (IN); Giuseppe MARCHIONNI, Milano (IT); Ivan Diego WLASSICS, Garessio (IT); Sibdas SINGHAMAHAPATRA, Vadodara (IN)

(21) Appl. No.: 15/773,380

(22) PCT Filed: Oct. 28, 2016
(86) PCT No.: PCT/EP2016/076070

§ 371 Date: May 3, 2018

(30) Foreign Application Priority Data
Nov. 5, 2015 (IN) 4223/MUM/2015
Jan. 5, 2016 (EP) 16150135.8

(51) Int. Cl. C08L 77/06; C08G 69/42; C08G 81/00; C08G 65/22

(52) U.S. Cl. CPC C08L 77/06; C08G 65/223; C08G 81/00; C08G 69/42

(57) ABSTRACT

A method for providing a fluorinated polyamide is herein provided. The method envisages the copolymerization of a (per)fluoropolyether comprising amino or acid functional groups with a mixture of a hydrogenated dicarboxylic acid and a diamine and/or an aminoacid or lactam in the presence of a hydrogenated monocarboxylic acid and/or a hydrogenated monoamine. By appropriate selection of the functionality of the reaction mixture, fluorinated polyamides having an average molecular weight (M_{w}) lower than 16,000 and a content of PFPE segments ranging from 5% to 50% wt are obtained. These polyamides can be advantageously used as additives for other polyamides, in particular for non-fluorinated polyamides to provide blends that can be formed into shaped articles.

### CROSS-REFERENCE TO PREVIOUS APPLICATIONS

This application claims priority to Indian provisional patent application No. 4223/MUM/2015 filed on Nov. 5, 2015 and to European patent application No. 16150135.8 filed on Jan. 5, 2016, the whole content of each of these applications being incorporated herein by reference for all purposes.

### TECHNICAL FIELD

The present invention relates to polyamides, in particular to fluorine-containing polyamides useful as additives for other polyamides.

### BACKGROUND ART

Thermoplastic polyamides are widespreadly used as engineering plastics, mainly in the manufacture of automotive and electronic components and in the field of packaging. For these applications, it is often required that the polyamides have:
high hydro- and oleo-phobicity;
low brittleness (or high impact strength), i.e. low tendency to crack, especially when they are exposed to cold temperatures or mechanical stress;
a low coefficient of friction;
good flowability and
good processability. In order to obtain such properties, either finished polyamides can be blended with additives (e.g. plasticizers or impact modifiers if it is desired to reduce brittleness) or they can be synthesised in the presence of specific comonomers. However, the insertion of additives or the use of certain comonomers may alter or reduce other properties which would instead be desirable to retain or even increase, including hydro- and oleo-phobicity.

It is known in the art that functional (per)fluoropolyethers (herein after “PFPEs”) can be used as additives or as comonomers (frequently referred to as “comacromers”) for the manufacture of additives for other polymers in order to modify certain physical/chemical properties of the polymer concerned.

For example, the following patent documents teach the use of functional PFPEs as comacromers in the course of polymerization, thereby obtaining modified polymers, namely polyurethanes (PUs), polyurethane/polyesters (PUs/PEs) or polyesters (PEs), having a PFPE covalently bound thereto EP 1864685 A (SOLVAY SOLEXIS S.P.A.), U.S. Pat. No. 5,476,910 (AUSIMONT S.P.A.), U.S. Pat. No. 5,686,522 (AUSIMONT S.P.A.) and U.S. Pat. No. 5,109,103 (AUSIMONT S.P.A.).

U.S. Pat. No. 6,127,498 (AUSIMONT S.P.A.) discloses modified hydrogenated polymers obtainable by polycondensation or polyaddition reaction or by grafting a monomer, oligomer or polymer with a PFPE derivative comprising a monofunctional PFPE chain wherein a reactive terminal group T is bound to the PFPE chain via a bivalent radical A which may comprise amidic groups. The modified polymers can be used for the manufacture of articles endowed with improved surface properties. This document does not specifically mention polyamides, nor does it provide working examples related to modified polymers wherein A contains an amide group.

WO 2009/010533 (SOLVAY SOLEXIS S.P.A.) discloses polymers obtained by reaction of a hydrogenated polymer containing optionally substituted aromatic groups with a PFPE peroxide. In the resulting polymer, the aromatic ring is linked to the PFPE chain via a non-hydrolysable covalent bond. Said polymers are endowed with improved stability to high temperature and oxidizing media, improved chemical resistance and improved surface properties. Even if the hydrogenated polymer reacted with the PFPE peroxide can be a polyamide, this document neither mentions nor suggests polymers wherein the PFPE chain is linked to the hydrogenated polymer via an amide bond.

U.S. Pat. No. 3,876,617 (MONTEDISON S.P.A.) discloses elastomeric polyamides and copolyamides which can be obtained by reacting a PFPE diacid of formula:

HOOC—CF₂O—(C₂F₄O)ₗ—(CF₂O)ₙ—CF₂COOH

(in which l and n are integers selected in such a way that the C₂F₄O/CF₂O ratio ranges from 0.2 to 1.5), preferably in the form of a reactive derivative, with a diamine. In particular, in U.S. Pat. No. 3,876,617 it is stated that the polyamides can also contain further monomeric units with more than two functions, like carboxylic groups, to an extent up to 30% in number with respect to the bifunctional units. The amount of PFPE diacid contained in these polyamides is high and, for this reason, the resulting polyamide is endowed with elastomeric properties. Furthermore, this document does not specifically disclose polyamides obtained by reaction of a PFPE diacid, a diamine and a polycarboxylic acid.

WO 2010/049365 (SOLVAY SOLEXIS S.P.A) relates to polymers comprising PFPE segments and non-fluorinated segments as additives for hydrogenated polymers to give them good surface properties, in particular a low coefficient of friction (page 1, lines 1-3). The non-fluorinated segments have at least one crystalline phase that melts at a temperature of at least 25° C. This document discloses, inter alia, polyamide additives which can be obtained by reacting a non-fluorinated diamine with a PFPE having ester or carboxyl functionality, in an equivalent amount of amino groups equal to that of the functional groups of the diamine (reference is made to page 10, lines 5 to 8). This document does not disclose the copolymerization of a PFPE diacid with a hydrogenated diamine and a hydrogenated diacid. Furthermore, it is understood that, in view of the high content of fluorine in these polymers, in order to use them as additives (otherwise referred to as masterbatches), they must be first be diluted in diluted in a hydrogenated polymer.

U.S. Pat. No. 5,143,963 (RES DEVELOPMENT CORP) discloses a composition of matter formed by melt-blending a thermoplastic polymer and from 0.01% to less than 1% wt of a fluorocarbon additive, the additive having a lower surface energy than the polymer, due to the fact that the fluorocarbon additive has a higher concentration at the surface of the composition. The thermoplastic polymer can be a polyamide (col. 4, line 31-39) and the fluorocarbon additive can be a PFPE (col. 5, lines 2-3). This document does not disclose or suggest polyamides incorporating PFPE segments.

WO 99/23148 (E.I. DU PONT DE NEMOURS AND COMPANY) relates to a wear-resistance article comprising a thermosetting polymer-fluorocarbon composition and to a method for making said article (page 1, lines 5 and 6). It is taught that the incorporation of the fluorocarbon in the polymer “greatly increases the longevity or permanence of the beneficial effect compared to surface treatment of the polymeric additive with a fluorocarbon”. Among the thermosetting polymers specifically mentioned on page 6, lines 9-17, polyamides are not mentioned.

WO 91/03523 (COATES BROTHERS PLC) discloses a coating composition comprising a fluorine-containing polyamide. The polyamide can be obtained by polycondensation of a polycarboxylic acid component, a polyamine component and, commonly, monocarboxylic acids or monoamines to control the molecular weight of the final polyamide. The fluorine atoms can be derived from one or more of the reactants or can be introduced during or after the polycondensation. Thus document does not provide any hint or suggestion to polyamides wherein the polycarboxylic or polyamine component is a carboxylic or amino derivative of a fully or partially fluorinated polyether.

WO 2015/097076 (SOLVAY SPECIALTY POLYMERS ITALY S.P.A.) discloses polyamides comprising recurring units derived from monomers (A) and (B), wherein:

monomer (A) is selected from at least one of:
(i) a mixture of:
one or more hydrogenated aliphatic, cycloaliphatic or aromatic diamine(s) [diamine (NN)] or derivative(s) thereof; and
one or more hydrogenated aliphatic, cycloaliphatic or aromatic dicarboxylic acid(s) [acid (DA)] or derivative(s) thereof;
   (ii) one or more aminoacid(s) [aminoacid (AN)] or lactam(s) [lactam (L)] and wherein
   monomer (B) is at least one (PFPE-M) monomer selected from a PFPE-diamine (PFPE-NN) and PFPE-dicarboxylic acid (PFPE-DA).

These polyamides are characterised in that the amount of monomer (B) ranges from 0.1 to 10% wt, preferably from 1 to 5% wt, with respect to the overall weight of monomers (A) and (B).

Thus, this document teaches to modify a polyamide by inserting an amount of PFPE which can be as high as 10% wt with respect to the overall weight of monomers in order to improve the polyamide properties, in particular surface properties, chemical resistance, and to reduce brittleness. This document teaches that the PFPE monomer has an average functionality (F) of at least 1.80 preferably of at least 1.95.

It would be desirable to provide further modified polyamides comprising a high amount of PFPE units and that can be used as additives for other polyamides, in particular non-fluorinated polyamides, in order to improve their physical/chemical properties.

### SUMMARY OF INVENTION

The Applicant has now found out a convenient method [method (M)] for the manufacture of further polyamides comprising (per)fluoropolyether segments [polyamides (F-PA)]. Polyamides (F-PA) obtainable through method (M) have a lower molecular weight than the polyamides disclosed in WO 2015/097076, contain a high amount of fluorine and can be conveniently used as additives for other polyamides.

Method (M) envisages the copolymerization of a mixture of:
a hydrogenated diamine and a hydrogenated dicarboxylic acid (or of a hydrogenated aminoacid or lactam);
a PFPE amino or carboxyl derivative comprising mono- and/or bi-functional species
   in the presence of
a hydrogenated monocarboxylic acid or a hydrogenated monoamine and is characterised in that the amount of the reagents is selected in such a way as the average functionality (F_{RM}) of the reaction mixture is lower than 1.96.

It has indeed been observed that, under these conditions it possible to limit the growth of the polyamide chain in such a way that a molecular weight (M_{w}) of at most 16,000 is obtained.

The polyamides (F-PA) obtained with method (M) have two extremes, at least one of which comprises an end-capping group deriving from the hydrogenated monocarboxylic acid or monoamine and, optionally, an end-capping group deriving from the monofunctional species present in the PFPE amino or carboxyl derivative.

Polyamides (F-PA) obtainable with method (M) represent a further aspect of the present invention.

Further aspects of the invention are the use of polyamides (F-PA) as additives for the manufacture of polyamide blends [blends (B)] and formed articles obtained from such blends.

### General Definitions and Symbols

For the sake of clarity, throughout the present application:
any reference back to each generic embodiment of the invention is intended to include each specific embodiment falling within the respective generic embodiment, unless indicated otherwise;
the term “(per)fluoropolyether” stands for a fully or partially fluorinated polyether;
“PFPE” stands for “(per)fluoropolyether”, i.e. for a fully or partially fluorinated polyether; when used as substantive, “PFPE” and “PFPEs” respectively denote the singular or the plural form;
the use of brackets “( )” before and after symbols or numbers identifying compounds or formulae, e.g. “polyamide (F-PA)”, “diamine (NN)”, “diacid (AA)”, etc. . . . , has the mere purpose of better distinguishing those symbols or numbers from the rest of the text; thus, said parentheses could also be omitted;
an “end-capping group” is a terminal group present at one or both extremes of polyamide (F-PA). This group is formed by condensation reaction of the hydrogenated monocarboxylic acid or monoamine and, optionally, the monofunctional species in the PFPE amino or carboxy derivative, with the last amino or carboxy group at one or both ends of the polyamide chain to form an amido bond;
when numerical ranges are indicated, range ends are included;
a “cycloalkyl group” is a univalent group derived from a cycloalkane by removal of an atom of hydrogen; the cycloalkyl group thus comprises one end which is a free electron of a carbon atom contained in the cycle, which able to form a linkage with another chemical group;
a “divalent cycloalkyl group” is a divalent radical derived from a cycloalkane by removal of two atoms of hydrogen from two different carbons in the cycle; a divalent cycloalkyl group thus comprises two ends, each being able to form a linkage with another chemical group;
the adjective “aromatic” denotes any mono- or polynuclear cyclic group (or moiety) having a number of π electrons equal to 4n+2, wherein n is 0 or any positive integer; an aromatic group (or moiety) can be an aryl or an arylene group (or moiety);
an “aryl group” is a hydrocarbon monovalent group consisting of one core composed of one benzenic ring or of a plurality of benzenic rings fused together by sharing two or more neighboring ring carbon atoms, and of one end. Non limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group;
an “arylene group” is a hydrocarbon divalent group consisting of one core composed of one benzenic ring or of a plurality of benzenic rings fused together by sharing two or more neighboring ring carbon atoms, and of two ends. Non limitative examples of arylene groups are phenylenes, naphthylenes, anthrylenes, phenanthrylenes, tetracenylenes, triphenylylenes, pyrenylenes, and perylenylenes. An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.
The adjective “hydrogenated” in the expressions “one or more hydrogenated aliphatic, cycloaliphatic or aromatic diamine(s) [diamine (NN)] or derivative(s) thereof”, “one or more hydrogenated aliphatic, cycloaliphatic or aromatic dicarboxylic acid(s) [diacid (AA)] or derivative(s) thereof” and “a compound (C), which is at least one hydrogenated aliphatic, cycloaliphatic or aromatic monoamine [amine (N)] or a derivative thereof or at least one hydrogenated aliphatic, cycloaliphatic or aromatic monocarboxylic acid [acid (A′)]” is referred to the aliphatic species [i.e. aliphatic diamine (NN), aliphatic diacid (AA), aliphatic amine (N′) and aliphatic acid (A′) and is used to indicate that the alkylene or alkyl chain in those species contains only carbon an hydrogen atoms;
the expression “or (a) derivative(s) thereof” referred to monomers (A), (B) and compound (C) is intended to denote derivatives able to form amide groups.

Method (M)

In a first aspect, the present invention relates to a method (M) for the manufacture of a fluorinated polyamide (F-PA) which comprises, preferably consists of, the copolymerization of:

(a) a monomer (A), selected from at least one of:
(i) a mixture of:
one or more hydrogenated aliphatic, cycloaliphatic or aromatic diamine(s) [diamine (NN)] or derivative(s) thereof; and
one or more hydrogenated aliphatic, cycloaliphatic or aromatic dicarboxylic acid(s) [diacid (AA)] or derivative(s) thereof;
   (ii) one or more aminoacid(s) [aminoacid (AN)] or derivative(s) thereof or lactam(s) [lactam (L)];
   with
   (b) a monomer (B), which is a (per)fluoropolyether mixture (PFPE-M) selected from at least one of:
a mixture [mixture (MN)] of a PFPE-diamine (PFPE-NN) and a PFPE monoamine (PFPE-N) or derivative(s) thereof and
a mixture [mixture (MA)] of a PFPE-dicarboxylic acid (PFPE-AA) and a PFPE monocarboxylic acid (PFPE-A) or derivative(s) thereof, optionally in the presence of
   (c) a compound (C), which is at least one hydrogenated aliphatic, cycloaliphatic or aromatic monoamine [amine (N′)] or a derivative thereof or at least one hydrogenated aliphatic, cycloaliphatic or aromatic monocarboxylic acid [acid (A′)] or a derivative thereof, characterised in that the average functionality (F_{RM}) of the mixture of monomers (A), (B) and compound (C) [herein after “reaction mixture (MR)”] is lower than 1.96.

The average functionality (F_{RM}) is the ratio between the overall equivalents of monomers (A), (B) and compound (C) and the overall moles of monomers (A), (B) and compound (C), according to the following equation:

(F_{RM})=[eq(A)+eq(B)+eq(C)]/[mol(A)+mol(B)+mol(C)]

### Monomer (A)

Diamine (NN) is generally selected from the group consisting of primary and secondary alkylene-diamines, cycloaliphatic diamines, aromatic diamines and mixtures thereof.

Diamine (NN) typically complies with general formula (NN-I)

R—HN—R¹—NH—R′ (NN-I)

wherein:
R and R′, equal to or different from one another, are selected from hydrogen, straight or branched C₁-C₂₀ alkyl and aryl as defined above, preferably phenyl;
R¹ is: (i) a straight or branched aliphatic alkylene chain having 2 to 36 carbon atoms, optionally comprising one or more divalent cycloalkyl groups or arylene groups as defined above; (ii) a divalent cycloalkyl group or (iii) an arylene group as defined above.

In amine (NN-I), a divalent cycloalkyl group preferably comprises from 3 to 6 carbon atoms, and, optionally, one or more oxygen or sulphur atoms.

In one embodiment, diamine (NN) is a primary alkylene diamine. Primary alkylene diamines are advantageously selected from the group consisting of 1,2-diaminoethane, 1,2-diaminopropane, propylene-1,3-diamine, 1,3-diaminobutane, 1,4-diaminobutane, 1,5-diaminopentane, 1,5-diamino-2-methyl-pentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,8-diamino-2-methyloctane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane, 1,12-diaminododecane, and 1,13-diaminotridecane. The aliphatic alkylene diamine preferably comprises at least one diamine selected from the group consisting of 1,2-diaminoethane, 1,4-diamino butane, 1,6-diaminohexane, 1,8-diamino-octane, 1,10-diaminodecane, 1,12-diaminododecane and mixtures thereof. More preferably, the aliphatic alkylene diamine is selected from 1,2-diaminoethane, 1,6-diaminohexane, 1,10-diaminodecane and mixtures thereof.

Examples of primary alkylene diamines wherein the alkylene chain comprises an arylene group are meta-xylylene diamine (MXDA), and para-xylylene diamine. More preferably, the diamine is MXDA.

In another embodiment, diamine (NN) is a secondary diamine. Non-limiting examples of secondary diamines are N-methylethyelene diamine, N,N′-diethyl-1,3-propanediamine, N,N′-diisopropylethylenediamine, N,N′-diisopropyl-1,3-propanediamine and N,N′-diphenyl-para-phenylenediamine.

Derivatives of diamine (NN) can be used for carrying out method (M); such derivatives include notably salts thereof, equally able to form amide groups.

Diacid (AA) can be an aliphatic dicarboxylic acid [acid (AL)] or a dicarboxylic acid comprising at least one aryl or arylene group as defined above [acid (AR)]. Non limitative examples of diacids (AR) are notably phthalic acids, including isophthalic acid (IA), and terephthalic acid (TA), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid. Among acids (AL), mention can be notably made of oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tetradecanedioic acid [HOOC—(CH₂)₁₂—COOH], octadecanedioic acid [HOOC—(CH₂)₁₆—COOH], 2,5-furandicarboxylic acid and tetrahydrofuran-2,5-dicarboxylic acid. Preferably, diacid (AA) is an acid (AL), as above detailed. Preferred examples of acids (AL) are adipic acid and sebacic acid; more preferably, acid (AL) is adipic acid.

Derivatives of diacid (AA) can be used for carrying out method (M); such derivatives include notably salts, anhydrides, esters and acid halides, able to form amide groups.

Among suitable aminoacids (AN) for the manufacture of polyamide (PA), mention can be made of those selected from the group consisting of 6-amino-hexanoic acid, 9-aminononanoic acid, 10-aminodecanoic acid, 11-aminoundecanoic acid, 12-aminododecanoic acid. Derivatives of aminoacids (AN) can also be used for carrying out method (M); such derivatives include notably, salts, esters and acid halides, able to form amide groups.

Among suitable lactams (L) for the manufacture of polyamide (PA), mention can be made of β-lactam and ε-caprolactam.

### Monomer (B) (PFPE-M)

Mixture (MN) is a mixture of fluoropolymers comprising a fully or partially fluorinated polyalkyleneoxy chain [(per)fluoropolyoxylakylene chain (R_{f})] having two chain ends, wherein one or both chain ends comprise an amino group or a derivative thereof able to form amide groups, notably a salt. Mixture (MN) may also comprise negligible amounts of non-functional species, i.e. fully or partially fluorinated straight or branched polyalkyleneoxy chain [(per)fluoropolyoxylakylene chain (R_{f}) wherein both ends bear a non-functional group.

Mixture (MA) is a mixture of fluoropolymers comprising a fully or partially fluorinated straight or branched polyalkyleneoxy chain [(per)fluoropolyoxylakylene chain (R_{f})] having two chain ends, wherein one or both chain ends comprise a —COOH group or a derivative thereof able to form amide groups; preferably, the derivative is an ester derivative. Mixture (MA) may also comprise negligible amounts of non-functional species, i.e. fully or partially fluorinated straight or branched polyalkyleneoxy chain [(per)fluoropolyoxylakylene chain (R_{f}) wherein both ends bear a non-functional group.

The amount of mono- and bifunctional polymers, and, optionally, non-functional polymers in mixtures (PFPE-M) is expressed by means of the average functionality [herein after (F_{B})], which is defined as:

(F_{B})=[2×moles of (PFPE-AA) or (PFPE-NN)+1×moles of (PFPE-A) or (PFPE-N)/(moles of non-functional PFPE+moles of (PFPE-A) or (PFPE-N)+moles of (PFPE-AA) or (PFPE-N)].

Average functionality (F_{B}) can be calculated by means of ¹H-NMR and ¹⁹F-NMR analyses according to methods known in the art, for example following the teaching of U.S. Pat. No. 5,910,614 (AUSIMONT SPA) with suitable modifications.

Typically, mixtures (PFPE-M) used in method (M) have an average functionality (F_{B}) of at least 1.80; advantageously, (F_{B}) ranges from 1.80 to 1.95, more advantageously from 1.85 to 1.90.

Chain (R_{f}) comprises recurring units R° having at least one catenary ether bond and at least one fluorocarbon moiety, said repeating units, randomly distributed along the chain, being selected from the group consisting of:

(i) —CFXO—, wherein X is F or CF₃,
(ii) —CFXCFXO—, wherein X, equal or different at each occurrence, is F or CF₃, with the proviso that at least one of X is —F,
(iii) —CF₂CF₂CW°₂O—, wherein each of W°, equal or different from each other, is F, Cl, H,
(iv) —CF₂CF₂CF₂CF₂O—,
(v) —(CF₂)ⱼ—CFZ*—O— wherein j is an integer from 0 to 3 and Z* is a group of general formula —OR_{f}*T°, wherein R_{f}* is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of X being independently F or CF₃ and T° being a C₁-C₃ perfluoroalkyl group.

Preferably, chain (R_{f}) complies with the following formula:

(CFX¹O)_{g1}(CFX²CFX³O)_{g2}(CF₂CF₂CF₂O)_{g3}(CF₂CF₂CF₂CF₂O)_{g4}— (R_{f}-I)

wherein:
X¹ is independently selected from —F and —CF₃,
X², X³, equal or different from each other and at each occurrence, are independently —F, —CF₃, with the proviso that at least one of X is —F;
g1, g2 g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—(CF₂CF₂O)ₐ₁(CF₂O)ₐ₂— (R_{f}-IIA)

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10, more preferably between 0.3 to 3;

—(CF₂CF₂O)_{b1}(CF₂O)_{b2}(CF(CF₃)O)_{b3}(CF₂CF(CF₃)O)_{b4}— (R_{f}-IIB)

wherein:
b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being 1;

—(CF₂CF₂O)_{c1}(CF₂O)_{c2}(CF₂(CF₂)_{cw}CF₂O)_{c3}— (R_{f}-IIC)

wherein:
cw=1 or 2;
c1, c2, and c3 are independently integers ≥0 chosen so that the number average molecular weight is between 400 and 10,000, preferably between 400 and 5,000; preferably c1, c2 and c3 are all >0, with the ratio c3/(c1+c2) being generally lower than 0.2;

—(CF₂CF(CF₃)O)_{d}— (R_{f}-IID)

wherein:
d is an integer >0 such that the number average molecular weight is between 400 and 10,000, preferably between 400 and 5,000;

—(CF₂CF₂C(Hal)₂O)ₑ₁—(CF₂CF₂CH₂O)ₑ₂—(CF₂CF₂CH(Hal)O)ₑ₃— (R_{f}-IIE)

wherein:
Hal, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—(CF₂CF₂O)ₐ₁(CF₂O)ₐ₂— (R_{f}-III)

wherein:
a1, and a2 are integers >0 such that the number average molecular weight is between 400 and 5,000, with the ratio a2/a1 generally ranging from 0.3 to 3.

Mixture (PFPE-M) preferably complies with general formula (I) here below:

A-O—R_{f}-A′ (I)

wherein:
R_{f} is as defined above;
A and A′, equal to or different from one another, represent a C₁-C₃ haloalkyl group, typically selected from —CF₃, —CF₂C₁, —CF₂CF₂Cl, —C₃F₆Cl, —CF₂Br and —CF₂CF₃ or a group of formula:

CF₂-Lₓ-T

in which:
L represents a bivalent radical selected from:
   (a) a C₁-C₂₀ straight or branched C₃-C₂₀ alkylene chain (Cₐₗₖ), optionally containing one or more heteroatoms selected from O, N, S and P and/or one or more groups of formula —C(O)—, —C(O)O—, —CO(O)O—, —C(O)NH—, —NHC(O)NH— and —C(O)S—, said chain optionally containing a (heterocyclo)aliphatic ring (Rₐₗᵢ) or (heterocycloaromatic) ring (Rₐᵣ) as defined herein below;
   (b) a C₃-C₁₀ cycloaliphatic ring (Rah), optionally substituted with one or more straight or branched alkyl groups, preferably C₁-C₃ alkyl groups, and optionally containing one or more heteroatoms selected from N, O, S or groups of formula —C(O)—, —C(O)O— and —C(O)NH; the cycloaliphatic ring can also be linked to or condensed with a further ring (Rₐₗᵢ) or with a C₅-012 aromatic or heteroaromatic ring (Rₐᵣ) as defined herein below, which can optionally be substituted with one or more straight or branched alkyl groups, preferably C₁-C₃ alkyl groups;
x is 0 or 1;
   (c) a C₅-C₁₂ aromatic ring (Rₐᵣ), optionally containing one or more heteroatoms selected from N, O, S and optionally being substituted with one or more straight or branched alkyl groups, preferably C₁-C₃ alkyl groups; optionally, ring (Rₐᵣ) can be linked to or condensed with another equal or different ring (Rₐᵣ);
T is a —COOH or —NH₂ group or a derivative thereof as defined above.

Typically, in groups CF₂-Lₓ-T, x is 1 and linking group L comprises one of the following groups W, said group W being directly bound to the —CF₂— group between chain (R_{f}) and linking group L: —CH₂O—, —CH₂OC(O)NH—, —CH₂NR¹— in which R¹ is hydrogen or straight or branched C₁-C₃ alkyl, and —C(O)NH—. It has indeed been observed that monomers (B) wherein x is 1 are advantageous in that they are particularly reactive and compatible with amines (NN) and acids (AA) and in that they are also thermally and chemically stable.

Preferred examples of mixtures (PFPE-M) are those wherein A and/or A′ are selected from the following groups:

—CF₂CH₂O-alkylene-T; (a¹)

—CF₂CH₂O(alkylene-O)ₙ—C*ₐₗₖ-T; (b¹)

—CF₂CH₂O-alkylene-C(O)NH-alkylene-T; (c¹)

—CF₂CH₂NR¹-alkylene-T; (d¹)

—CF₂CH₂NR¹(alkylene-NR¹)ₙ—C*ₐₗₖ-T; (e¹)

—CF₂CH₂NR¹-alkylene-C(O)O-alkylene-T; (f¹)

—CF₂CH₂NR¹-alkylene-C(O)NH-alkylene-T; (g¹)

—CF₂C(O)NH—(C*ₐₗₖ)-T (h¹)

—CF₂C(O)NH—(R*ₐₗᵢ)-T; and (i¹)

—CF₂C(O)NH—(R*ₐᵣ)-T (l¹)

wherein:
alkylene is a C₁-C₂₀ straight or branched C₃-C₂₀ alkylene chain, preferably a C₁-C₁₂ chain;
n is a positive number ranging from 1 to 10, preferably from 1 to 5, more preferably from 1 to 3, extremes included;
T is as defined above;
R¹ is hydrogen or straight or branched C₁-C₃ alkyl;
C*ₐₗₖ, R*ₐₗᵢ and R*ₐᵣ have the same meanings as Cₐₗₖ, Rₐₗᵢ and Rₐᵣ defined above.

In mixtures (PFPE-M) wherein A and/or A′ are groups of formula (b¹), preferred (alkylene-O) moieties include —CH₂CH₂O—, —CH₂CH(CH₃)O—, —(CH₂)₃O— and —(CH₂)₄—.

Mixtures (PFPE-M) wherein x is 1 and L comprises a W group selected from —CH₂O—, —CH₂OC(O)NH— and —CH₂NR¹— in which R¹ is hydrogen or straight or branched C₁-C₃ alkyl can be obtained using as precursor a PFPE alcohol of formula (II) below:

Y—O—R_{f}—Y′ (II)

wherein R_{f} is as defined above and Y and Y′, equal to or different from one another, represent a C₁-C₃ haloalkyl group, typically selected from —CF₃, —CF₂C₁, —CF₂CF₂Cl, —C₃F₆Cl, —CF₂Br and —CF₂CF₃ or a group of formula —CF₂CH₂OH.

Suitable PFPE alcohols of formula (II) can be prepared by photoinitiated oxidative polymerization (photooxidation reaction) of per(halo)fluoromonomers, as described in U.S. Pat. No. 3,715,378 (MONTECATINI EDISON S.P.A.) and U.S. Pat. No. 3,665,041 (MONTEDISON S.P.A.). Typically, mixtures of perfluoropolyethers can be obtained by combination of hexafluoropropylene and/or tetrafluoroethylene with oxygen at low temperatures, in general below −40° C., under U.V. irradiation, at a wavelength (A) of less than 3 000 Å. Subsequent conversion of end-groups as described in U.S. Pat. No. 3,847,978 (MONTEDISON S.P.A.) and in U.S. Pat. No. 3,810,874 notably carried out on crude products from photooxidation reaction. It is known to persons skilled in the art that PFPE alcohols (II) manufactured by photoinitiated oxidative polymerization are obtained as mixtures of bi- and mono-functional PFPE alcohols and non-functional (otherwise referred to as “neutral”) PFPEs. The monofunctional PFPE alcohols and the neutral PFPEs comprised in PFPE alcohols (II) have a C₁-C₃ haloalkyl group as defined above at one or both ends of chain R_{f}. Usually, the amount of neutral PFPEs is lower than 0.04% by moles with respect to the overall molar amount of bi-, mono-functional PFPE alcohols and neutral PFPEs. PFPE alcohols (II) are thus characterised by an average functionality (F°), defined as:

[(2×moles of bi-functional PFPE alcohol)+moles of monofunctional PFPE alcohol]/moles of bi-functional PFPE alcohol+moles of monofunctional PFPE alcohol+moles of neutral PFPE.

It will thus be understood by a person skilled in the art that, when a PFPE alcohol (II) having a functionality (F°) is used as precursor of a mixture (PFPE-M) by reaction with a suitable reaction partner at full conversion and 100% selectivity, the functionality of mixture (F_{B}) will be equal to)(F°. Mixture (PFPE-M) will thus further comprise a PFPE-A or PFPE-N and neutral PFPEs wherein one of A or A′ or both A and A′ respectively is(are) the same as the C₁-C₃ haloalkyl group respectively present at one or both ends of the starting PFPE alcohol (II) [Y and Y′ in formula (II)].

Mixtures (PFPE-M) wherein W is —CH₂O— can be obtained by reaction of PFPE alcohol (II) with a compound of formula E-B*-T, wherein E represents a leaving group, B* represents a group selected from Cₐₗₖ, R*ₐₗᵢ and R*ₐᵣ and T is amino or carboxy, optionally in a protected form. Suitable leaving groups E include halogens, preferably chlorine and bromine, and sulfonates like trifluoromethanesulfonate. Preferred protecting groups for —COOH groups are esters, while preferred protecting groups for —NH₂ groups are amides and phthalimides. As an alternative, the terminal hydroxy groups in the PFPE alcohol of formula (II) can be transformed into a leaving group E as defined above and reacted with a compound of formula HO-B*-T wherein B* and T are as defined above.

Typically, mixtures (PFPE-M) wherein A and/or A′ represent groups of formula (a¹) as defined above can be obtained by reaction of a PFPE alcohol (II) with a compound of formula E-C*ₐₗₖ-T, wherein E, C*ₐₗₖ and T are as defined above. A preferred example of mixture (PFPE-M) comprising (PFPE-AA) and (PFPE-A) wherein group (a¹) is —CF₂CH₂O—CH₂-T can be obtained by reaction of a PFPE-diol (II) with an ester of a 2-halo-acetic acid, for example with 2-chloroethyl acetate.

Mixtures (PFPE-M) wherein A and A′ represent groups of formula (b¹) as defined above can be synthesised by condensation reaction of a PFPE alcohol (II) with a diol of the type HO-alkylene-OH or by ring-opening reaction of a PFPE alcohol (II) with ethylene oxide or propylene oxide, to provide a hydroxyl compound which is either reacted with compound of formula E-C*ₐₗₖ-T or submitted to conversion of the hydroxyl end groups into leaving groups E as defined above and reacted with a compound of formula HO—C*ₐₗₖ-T.

Mixtures (PFPE-M) wherein A and A′ represent groups (c¹) as defined above can be synthesised by reaction of a Mixture (PFPE-M) wherein A and/or A′ represent groups —CF₂CH₂O-alkylene-COOH or derivative thereof with a diamine or aminoacid of formula NH₂-alkylene-T, wherein alkylene and T are as defined above.

Mixtures (PFPE-M) wherein x is 1 and L comprises a W group of formula —CH₂NHR¹— in which R¹ is as defined above can be obtained by reaction of a PFPE alcohol (II), whose hydroxyl end groups E have been transformed into leaving groups E, with a compound of formula R¹HN-B*-T wherein R¹, B* and T are as defined above.

For example, mixtures (PFPE-M) wherein A and/or A′ represent groups of formula (d¹) as defined above can be synthesised by reaction of a PFPE alcohol (II) with an amine of formula R¹NH-alkylene-T, wherein R¹ and alkylene are as defined above and wherein T is optionally in a protected form.

Mixtures (PFPE-M) wherein A and/or A′ represent groups of formula (e¹) as defined above can be synthesised by reaction of a PFPE alcohol (II) with a polyamine of formula R¹NH— (alkylene-NR¹)ₙ₋₁alkylene-NHR¹, wherein n and R¹ are as defined above, followed by reaction with a compound of formula E-C*ₐₗₖ-T, wherein E, C and T are as defined above.

Mixtures (PFPE-M) wherein A and/or A′ represent groups of formula (f¹) as defined above can be synthesised by reaction of a PFPE alcohol (II) with an aminoacid of formula R¹NH-alkylene-T, followed by reaction with a compound of formula HO-alkylene-T, wherein R¹ and T are as defined above.

Mixtures (PFPE-M) wherein A and/or A′ represent groups of formula (g¹) as defined above can be synthesised by reaction of a PFPE alcohol (II) with an aminoacid of formula R¹NH-alkylene-COOH, followed by reaction with a compound of formula NH₂-alkylene-T, wherein R¹ and T are as defined above.

As an alternative, mixtures (PFPE-M) wherein x is 1 and L comprises a W group of formula —CH₂NHR¹— in which R¹ is as defined above can be obtained by converting a PFPE alcohol (II) into the corresponding sulfonic ester derivative, by reaction, for example, with CF₃SO₂F and reacting the sulfonic diester with anhydrous liquid ammonia to provide a PFPE diamine of formula (III) below:

Y′—O—R_{f}—CF₂CH₂NH₂ (III)

wherein R_{f} is as defined above and Y′ is —CF₂CH₂NH₂ or is the same as Y as defined above.

PFPE diamine (III) can be reacted with a compound of formula E-B*-T, wherein E, B* and T are as defined above.

Mixtures (PFPE-M) wherein x is 1 and L comprises a W group of formula —C(O)NH— can be obtained using as precursor a PFPE diacid of formula (IV) below:

Y″—O—R_{f}—CF₂COOH (IV)

in which R_{f} is as defined above and Y″ is —CF₂COOH or is the same as Y as defined above
or a reactive derivative thereof, preferably an ester derivative, typically a methyl or ethyl ester derivative.

Suitable PFPE ester derivatives of PFPE acids (IV) can be conveniently obtained as disclosed, for example, in U.S. Pat. No. 5,371,272 (AUSIMONT SPA). It is known to persons skilled in the art that, similarly to PFPE alcohols (II), also PFPE acids (IV) are obtained as mixtures of bi-, mono-functional and neutral species and that the functionality of PFPE acids (IV) used as precursor of mixtures (PFPE-M) affects the functionality (F_{B}) of such mixtures in the same way as explained above for PFPE diols (II).

PFPE acids (IV) or reactive derivatives thereof can be reacted with compounds of formula N₂H-B*-T, wherein B* and T are as defined above.

In particular, mixtures (PFPE-M) wherein A and A′ comply with formulae (h¹)-(l¹) as defined above can be prepared by reaction of an ester derivative of an acid (IV) with a compound of formula NH₂—(C*ₐₗₖ)-T, NH₂—(R*ₐₗᵢ)-T or NH₂—(R*ₐᵣ)-T.

For the sake of clarity and accuracy, it is pointed out that, in certain instances, the synthesis of mixtures (PFPE-M) of formula (I) above can lead to the formation of a certain amount of dimeric or polymeric by-products; for example, in the synthesis of a mixture wherein A and/or A′ represent groups of formula:

—CF₂CH₂O-alkylene-C(O)NH-alkylene-NH₂; (c″*)

dimeric by products of formula:

A-O—R_{f}—CF₂CH₂O-alkylene-C(O)NH-alkylene-NH(O)C-alkylene-OCH₂CF₂—R_{f}—O-A

are obtained, due to the reaction of a diamine of formula: H₂N-alkylene-NH₂ with diacid of formula: HOOC-alkylene-O—CH₂CF₂—O—R_{f}—CF₂CH₂O-alkylene-COOH in a molar amount of 1 to 2.

Furthermore, in the synthesis of a (PFPE-MN) by reaction of a PFPE alcohol with an amine of formula R¹NH-alkylene-NH₂ in which R¹ is other than hydrogen, mixtures of regioisomers, for instance those of formulae: H₂N-alkylene-N(R¹)—CH₂CF₂—O—R_{f}—CF₂CH₂—N(R¹)-alkylene-NH₂. (R¹) HN-alkylene-NH— CH₂CF₂—O—R_{f}—CF₂CH₂—NH-alkylene-NH(R¹) can be obtained.

Thus, for the purposes of the present invention, the expressions “PFPE-MN”, “PFPE-MA”, are meant to encompass also any dimeric or polymeric by-products or regioisomers which may be formed in their synthesis.

### Compound (C)

Amine (N′) is at least one primary or secondary hydrogenated aliphatic, cycloaliphatic or aromatic amine or a derivative thereof.

Typically, amine (N′) complies with formula (N′-I):

R—NH—R² (N′-I)

wherein:
R is hydrogen or straight or branched C₁-C₂₀ alkyl and
R² is: (i) a straight or branched aliphatic alkyl chain comprising from 2 to 36 carbon atoms, optionally bearing one or more cycloalkyl or aryl groups and/or optionally being interrupted by one or more divalent cycloalkylene or arylene groups; (ii) a cycloalkyl group or (iii) an aryl group as defined above.

Preferably, amine (N′) is at least one straight or branched primary alkylamine having from 1 to 36 carbon atoms. More preferably, amine (N′) is selected from: methylamine, ethylamine, propylamine, butylamine, pentylamine, hexylamine, heptylamine, octylamine, nonylamine, decylamine, undecylamine, docedylamine and trydecylamine, being understood that all these terms include all existing straight and branched structural isomers. For example, “propylamine” includes 1-aminopropane and 2-amino-propane; “butylamine” includes 1-aminobutane, 2-aminobutane, 1-amino-2-methyl-propane and so on.

Derivatives of amine (N′) that can be used for carrying out method (M) include notably salts thereof, equally able to form amide groups.

Acid (A′) is a hydrogenated aliphatic, cycloaliphatic or aromatic monocarboxylic acid or a derivative thereof. According to one embodiment, acid (A′) is at least one straight or branched aliphatic acid comprising from 1 to 26 carbon atoms; preferably, acid (A′) is selected from ethanoic acid (acetic acid), propanoic acid, butanoic acid, pentanoic acid, hexanoic acid, heptanoic acid, octanoic acid, nonanoic acid, decanoic acid, dodecanoic acid and tridecanoic acid, being understood that all these terms include all existing straight or branched structural isomers. For example, “butanoic acid” includes 1-butanoic acid and 2-methylpropanoic acid. Preferably, hydrogenated aliphatic acid (A′) is acetic acid.

According to another embodiment, acid (A′) is an aromatic acid comprising at least one 5- or 6-membered aromatic ring wherein one sp² carbon atom bears a carboxy group covalently bound thereto and wherein one or more carbon atoms of the ring can be replaced with a heteroatom, said ring being optionally condensed with or covalently bound to, another 5- or 6-membered aromatic ring. The at least one aromatic ring can optionally be substituted on one or more sp² carbon atoms with a straight or branched alkyl group, preferably a C₁-C₄ alkyl group. Example of suitable aromatic acids are benzoic acid, 2-methyl benzoic acid, 3-methyl benzoic acid, 4-methyl benzoic acid, 2,3-dimethyl benzoic acid, 2,4-dimethyl benzoic acid, 2,5-dimethyl benzoic acid, 2,6-dimethyl benzoic acid, 2,3,4-trimethyl benzoic acid, 2,3,5-trimethyl benzoic acid, 2,3,6 trimethylbenzoic acid and 3,4,5-trimethyl benzoic acid. Preferably, hydrogenated aromatic acid (A′) is benzoic acid.

### Detailed Description of Method (M)

Method (M) can be carried out according to procedures known in the art for the synthesis of polyamides. Preferably, monomers (A), (B) and compound (C) are mixed together in a reactor under nitrogen atmosphere in the absence of solvents to form a reaction mixture (MR) and heated at temperatures that can range from 50° C. to 300° C. for a time ranging from 1 to 10 hours. Typically, the progress of the reaction is monitored by checking the torque of the reaction mixture; usually, when the torque value reaches a plateau, the reaction is regarded as complete. At the end of the reaction, the resulting fluorinated polyamide (F-PA), which is in the form of a molten mass, is poured into ice-cold water and then separated.

The kind and amounts of monomers (A), (B) and compound (C) will be selected by a person skilled in the art in such a way as the average functionality (F_{RM}) as defined above is lower than 1.96. Advantageously, (F_{RM}) will be selected in the range from 1.90 to 1.95.

Preferably, monomer (A) is a mixture of a diamine (NN), preferably an aromatic diamine (NN), with a diacid (AA), preferably an aliphatic dicarboxylic acid (AA); in one preferred embodiment, monomer (A) is a mixture of MXDA with adipic acid.

Monomer (B) is preferably a mixture (MA). More preferably, mixture (MA) is a mixture of formula (I) as defined above wherein A and/or A′ are a group (a¹). Still more preferably, mixture (MA) is a mixture of formula (I) as defined above in which A and/or A′ are a group (a¹) of formula —CF₂CH₂OCH₂COOH or a derivative thereof able to form amide groups, preferably an ester group, more preferably an ethyl ester group, and chain R_{f} is as defined above, preferably a chain (R_{f}-III). It has indeed been observed that fluorinated polyamides (F-PA) obtained using such mixture (M) are particularly stable to hydrolysis.

Preferably, compound (C) is an acid (A); preferred examples of acids (A) are acetic acid and benzoic acid.

The amount of monomers (A), (B) and (C) is selected in such a way as to achieve full balance between the equivalents of acid and amino groups (or derivatives thereof); in other words, the amount of said monomers is selected in such a way as the ratio between the equivalents of acid groups and amino groups is 1:1.

Monomer (B) is used in an equivalent amount preferably ranging from 0.50% to 20% with respect to monomer (A). Preferably, (PFPE-M) has an average functionality (F_{B}) ranging from 1.80 to 1.99, more preferably from 1.90 to 1.95 and an average molecular weight Mₙ ranging from 400 to 2,000.

Compound (C) is preferably used in an equivalent amount ranging from 2% to 6% with respect to monomer (A).

### Polyamides (F-PA)

A further aspect of the invention is represented by the fluorinated polyamides (F-PA) which can be obtained by method (M). The polyamides (F-PA) typically have an average molecular weight (M_{w}) lower than 16,000, preferably ranging from 8,000 to 16,000 and contain a weight amount of PFPE segments ranging from 5% to 50% wt with respect to the molecular weight of the polyamide, preferably from 5% to 40% wt, more preferably from 5% to 30% wt, even more preferably from 5% to 20% wt with respect to the weight of the polyamide. Average molecular weight (M_{w}) can be determined by gel permeation chromatography (GPC), according to methods known in the art.

The polyamides (F-PA) consist of recurring units deriving from monomers (A) and (B) and an end-capping group deriving from compound (C) and/or a (PFPE-N) and/or (PFPE-A) present in monomer (B).

Thus, polyamides (F-PA) according to the present invention consist of recurring units deriving from:

(a) a monomer (A), selected from at least one of:
(i) a mixture of:
one or more hydrogenated aliphatic, cycloaliphatic or aromatic diamine(s) [diamine (NN)] or derivative(s) thereof; and
one or more hydrogenated aliphatic, cycloaliphatic or aromatic dicarboxylic acid(s) [diacid (AA)] or derivative(s) thereof;
   (ii) one or more aminoacid(s) [aminoacid (AN)] or derivative(s) thereof or lactam(s) [lactam (L)];
   with
   (b) a monomer (B), which is at least one (per)fluoropolyether mixture (PFPE-M) selected from:
a mixture [mixture (MN)] of a PFPE-diamine (PFPE-NN) and a PFPE monoamine (PFPE-N) or derivative(s) thereof and
a mixture [mixture (MA)] of a PFPE-dicarboxylic acid (PFPE-AA) and a PFPE monocarboxylic acid (PFPE-A) or derivative(s) thereof said (F-PA) having
   (c) an end-capping group deriving from:
a compound (C), which is at least one hydrogenated aliphatic, cycloaliphatic or aromatic monoamine [amine (N′)] or at least one hydrogenated aliphatic, cycloaliphatic or aromatic amine or monocarboxylic acid [acid (A′)] or a derivative thereof and, optionally,
from (PFPE-N) and/or (PFPE-A).

Preferred polyamides (F-PA) are those wherein monomer (A) is a mixture of diamine (NN) and diacid (AA) and monomer (B) is a mixture (MN). Advantageously, diamine (NN) is MXDA and diacid (AA) is adipic acid.

Advantageously, the end-capping group derives from a compound (C) that is an acid (A′), preferably from benzoic acid or acetic acid.

Polyamide Blends [Blends (B)] Comprising Polyamides (F-PA), Shaped Articles Obtainable Therefrom and Methods for their Manufacture

In a further aspect, the present invention relates to blends (B) comprising a polyamide (F-PA) and a polyamide other than a polyamide (F-PA). Such other polyamide is preferably a hydrogenated polyamide [polyamide (H-PA)]obtainable by copolymerization reaction of:

(i) one or more hydrogenated aliphatic, cycloaliphatic or aromatic diamine(s) [diamine (NN)] or derivative(s) thereof with one or more hydrogenated aliphatic, cycloaliphatic or aromatic dicarboxylic acid(s) [diacid (AA)] or derivative(s) thereof; or
(ii) one or more aminoacid(s) [aminoacid (AN)] or derivative(s) thereof or lactam(s) [lactam (L)]
wherein diamine (NN), dicarboxylic acid (AA), aminoacid (AN) or derivative(s) thereof and lactam (L) are as defined above.

Diamine (NN), diacid (AA) and aminoacid (AN), independently from one another, can be equal to or different from those used for the preparation of polyamide (F-PA).

It has indeed been observed that, thanks to the structural features of polyamide (F-PA), namely molecular weight lower than 16,000 and content of PFPE segments, they can be used as additives for other polyamides to prepare blends and shaped articles that are endowed with improved hydro-/oleo-repellence and resistance to stain, improved chemical resistance and high impact strength.

Non-limiting examples of (H-PA) for the preparation of blends (B) are:
polyamides obtained by polycondensation of at least an aliphatic dicarboxylic acid (AA) with an aliphatic, cycloaliphatic or aromatic diamine (NN), such as PA 5.6, PA 6.6, PA 5.10, PA 5.12, PA 6.10, PA 6.12, PA 10.10, PA 10.6, PA 10.12, PA 12.12, PA 4.6, PA MXD6, PA 92, PA 102;
polyamides obtained by polycondensation of an aromatic dicarboxylic acid (AA) and an aliphatic or aromatic diamine (NN), such as polyterephthalamides of the type PA 4T, PA 9T, PA 10T, PA 10T/11, PA 10T/101, PA 10T/6T, PA 10T/106, PA 11T, PA 12T, PA 13T or 6T/MT, PA 6T/61, PA 66/6T, PA 66/6T/61 copolymers in various molar compositions in dicarboxylic acids, polyisophthalamides of the type PA 61, PA 61/6T, polynaphthalamides of the type PA 10N, PA 11N, PA 12N, polyarylamides like Kevlar®, as well as mixtures and (co)polyamides thereof;
polyamides obtained by polycondensation of at least one aminoacid (AN) or lactam (L), the aminoacid being possibly obtained by hydrolysis of a lactam, such as PA 6, PA 7, PA 11, PA 12, PA 13, as well as mixtures and (co)polyamides thereof. Polyamide 6/66, polyamide 6/11, polyamide 6/12 and polyamide 11/12 can be mentioned as examples of (co)polyamides.

In a preferred embodiment, polyamide (H-PA) results from the polycondensation of an aromatic diamine (NN) and with an aliphatic dicarboxylic acid (AA). A preferred (H-PA) of this sort is a polyamide obtained by polycondensation of MXDA with adipic acid.

Blends (B) can also contain other ingredients and/or additives commonly known in the art. Non-limiting examples of further ingredients and/or additives include heat-stabilizers, light and UV-light stabilizers, hydrolysis stabilizers, anti-oxidants, lubricants, plasticizers, colorants, pigments, antistatic agents, flame-retardant agents, nucleating agents, catalysts, mold-release agents, fragrances, blowing agents, viscosity modifiers, flow aids, reinforcing fibers and the like. Among reinforcing fibers, carbon fibers and glass fibers can be mentioned. The kind and amount of ingredients and/or additives will be selected by the skilled person according to common practice, for example following the teaching of ZWEIFEL, H, et al. Plastics Additives Handbook. 5th edition. Edited by HANSEL. Munich: Hanser, 2001. ISBN 1569901449.

Preferred blends (B) comprise, preferably consist of:

(a) one or more polyamide (F-PA) as defined above
(b) one or more hydrogenated polyamide (H-PA) as defined above; and
(c) one or more glass fibers.

Typically, blends (B) contain from 1% to 5% wt polyamide (F-PA), from 35% to 99% polyamide (H-PA) and from 30% to 60% wt glass fiber.

Blends (B) can be prepared and formed into shaped articles by techniques known in the art for the manufacture and shaping of plastics, such as for example molding methods, including injection molding, extrusion, blow molding and rotational molding.

Shaped articles obtained from blends (B) include those for automotive, electrical and electronic applications and packages.

The invention will be illustrated in greater detail in the following Experimental Section by means of non-limiting Examples.

Should the disclosure of any patents, patent applications, and publications which are incorporated herein by reference conflict with the description of the present application to the extent that it may render a term unclear, the present description shall take precedence.

### Experimental Section

### Materials

A mixture (PFPE-M) [(herein after PFPE ester (E-1)]

comprising the difunctional PFPE ester of formula:

EtO(O)CCH₂OCH₂O—R_{F}—CH₂OCH₂C(O)OEt

wherein R_{F}=CF₂(OCF₂)ₘ(OCF₂CF₂)ₙOCF₂ with n/m=1 and n+m selected in such a way as Mₙ=1,864 (determined by NMR) average functionality (F_{B})=1.87 and equivalent weight (E_{w})=997
was prepared following a procedure analogous to the one disclosed in Example 1 of WO 2015/097076 by reaction of a corresponding PFPE alcohol (II) with functionality 1.87 and ethyl chloroacetate.

A mixture [(herein after PFPE ester (E-2)]

of bi- and mono-functional PFPE esters and neutral PFPEs comprising the PFPE ester of formula:

EtO(O)C—R_{F}—C(O)OEt

as difunctional species
wherein R_{F}=CF₂(OCF₂)ₘ(OCF₂CF₂)ₙOCF₂ with n/m=1 and n+m selected in such a way Mₙ=1,500, E_{w}=802 average functionality (F_{B})=1.87, was prepared according to methods known in the art.

Non fluorinated polyamide MXD6 was obtained by copolymerization of a mixture of adipic acid and m-xylene diamine in equivalent amounts according to methods known in the art. This polyamide has a Mₙ=24,000, a M_{w}=54,874, a polydispersity index of 2.29 and an acidic content of 108 meq/kg.

Glass fiber OCV EC10 983 is available from Oven Cornings®.

The other reagents and solvents are commercially available and were used as received from the manufacturer.

### Analytical Methods—Tests

### Gel Permeation Chromatography (GPC)

The polyamides of the Examples and Comparative Examples and polyamide MXD6 were completely dissolved in hexafluoroisopropanol (HFIPA) containing 0.05M potassium trifluoro acetate (KTFAT). Any fillers and insoluble additives then filtered through 0.2 micron PTFE disposable syringe filters. The filtered solutions were separated on a size exclusion chromatography (SEC) system consisting of a Waters HPLC pump (model no. 515), Shodex refractive index (RI) detector (model no. 109), Waters column oven (capable for room temperature to 150° C.) maintained at 40° C. during the analysis, set of two mini mixed B SEC columns and mini mix B guard column (from Agilent), Clarity SEC integration software (Version 5.0.00.323). Mobile phase—HFIPA/0.05M potassium trifluoro acetate (KTFAT) at a flow rate of 0.4 mL/minute. The system was calibrated using the set of narrow polydispersed PMMA standard samples. The molecular weights were calculated using a calibration file generated using PMMA standards with the aid of a Clarity SEC integration software.

### Determination of the Acidic Content (Acid End Groups)

About 0.3 g polyamide was weighed in a glass vial with a magnetic stirring bar and dissolved in 6 mL o-cresol with heating at 100° C. After dissolution, the sample was cooled and diluted with 6 mL chloroform. 50 μL formaldehyde was added with a syringe to react with the amine end groups so as to suppress salt formation between the carboxyl and amine end groups. The carboxyl end groups were then titrated with standard 0.05N KOH in methanol using a combination glass electrode with sleeve junction. The acidic end group concentration was calculated from titration data and titrant normality, according to the following calculation:

Acidic value (meq/g)=(Volume of titrant (mL)×Normality of KOH×1000)/sample weight (g)

### Determination of the Glass Fiber Content (GF) in Polyamide Compositions

About 1 g polyamide composition was placed in a pre-weighed quartz fibre crucible. The crucible was then placed in a microwave furnace (Phoenix Airwave Microwave furnace from OEM). The temperature program was as follows:

heating from room temperature to 500° C. in 2 hrs;
maintained at 500° C. for 2 minutes;
500° C. to 600° C. in 30 minutes;
maintained at 600° C. for 90 minutes;
cooling from 600° C. to room temperature in 2 hrs.

Once the furnace was cooled to room temperature, the crucible was removed and re-weighed using an analytical balance.

The glass filler content was calculated by means of the following formula:

% Glass filler=[(Wt. of residue+Wt. of empty crucible)−Wt. of empty crucible]*100/[(Wt. of sample+Wt. of empty crucible)−Wt. of empty crucible].

### Contact Angle Measurements

Static contact angles of the polyamide blends (B-1)-(B-4), (B-1bis), reference blends (B-1a)-(B-4a) were measured against 2 μl water on a 2 mm fibre-reinforced injection molded slabs using a Dataphysics Contact Angle System OCA 20 instrument using the Sessile drop method. The images were captured after a fixed time of 10 seconds after dispensing the liquid. Multiple data points (16-20) were collected and the average and standard deviation was calculated.

### Spiral Flow Length Test

In order to measure the melt flow, an injection mold with a spiral flow was used. This mold was marked to measure the length (in mm) or the distance travelled by the polyamide blends during injection molding. Alternatively, the spiral mold specimen was weighed to measure the amount of polyamide in grams.

### Stability Test at Basic pH

1 g test polyamide and 1.5 equivalents NaOH (0.1 M solution) were charged in a flask equipped with magnetic stirrer and condenser. The resulting mixture was left under stirring at room temperature for 3 weeks.

The amide group hydrolysis was determined by treatment with an excess of HCl and back titration of the resulting ammonium salt with a 0.1N solution of tetrabutylammonium hydroxide in isopropyl alcohol.

### PREPARATION OF POLYAMIDES

### Example 1—PFPE-Modified Polyamide Comprising 10% Wt PFPE (Mₙ=4,856, M_{w}=10,002, Polydispersity Index 2.06)

Adipic acid (91.8 g, 0.63 mol, 1.26 eq), benzoic acid (15.0 g, 0.12 mol, 0.12 eq), xylylenediamine (MXDA, 47.65 g, 0.35 mol, 0.7 eq) and PFPE-ester (E-1) (18.8 g, 0.01 mol, 0.02 eq)

were placed in a 1 L four-necked cylindrical glass kettle equipped with a mechanical stirrer, condenser and nitrogen inlet and immersed in an oil bath. Temperature was raised to 100° C., then further 47.65 g of MXDA was added with continuous stirring and the bath temperature was raised up to 200° C. The reaction slurry at 200° C. was then heated up to the final oil bath temperature of 275° C. at the rate of 10° C./5 min. Once this temperature was reached, the reaction was continued until the required torque reached a plateau. The resulting melt was poured from the kettle by quenching in ice-cold water to provide a polymer mass. The mass was then dried and ground for further analyses.

The acidic content was 94 meq/kg and amine groups were not detected.

### Example 1A (Comparative Example)—PFPE Modified Polyamide (P-1A) Comprising 20% Wt PFPE (Mₙ=9,140, M_{w}=20,126, Polydispersity Index 2.20)

Following the procedure of Example 1, a polyamide was prepared with the following reagents:

adipic acid: 99.2 g, 0.68 mol, 1.36 eq;
MXDA: 90.6 g, 0.66 mol, 1.32 eq;
PFPE ester (E-1): 38.58 g, 0.02 mol, 0.04 eq.

The acidic content was 370 meq/kg and the content of amine groups was 5 meq/kg.

### Example 2—PFPE-Modified Polyamide Comprising 20% Wt PFPE (Mₙ=7,123, M_{w}=15,083, Polydispersity Index 2.12)

The following reagents:

adipic acid: 460.5 g, 3.15 mol, 6.30 eq;
MXDA: 456.9 g, 3.42 mol, 6.84 eq;
PFPE ester (E-1): 192.3, 0.10 mol, 0.20 eq;
acetic acid: 20.0 g, 0.33 mol, 0.33 eq
were charged in an autoclave at a pressure of 4.5 Pa and at a temperature from 30° C. to 250° C. for 3 hours. The reaction was considered complete when the torque value reached a plateau. Upon completion of the reaction, the resulting melt was discharged from the autoclave and processed as according to Example 1.

The acidic content was 125 meq/kg, which corresponded to a conversion of the starting acidic groups of about 98%.

### Example 2A (Comparative Example)—PFPE-Modified Polyamide Comprising 20% Wt PFPE (Mₙ 17,506, M_{w}=42,130, Polydispersity Index 2.41)

Following the procedure of Example 1, a polyamide was prepared with the following reagents:

adipic acid: 99.2 g, 0.68 mol, 1.36 eq;
MXDA: 96.0 g, 0.70 mol, 1.40 eq;
PFPE ester (E-1): 38.6 g, 0.02 mol, 0.04 eq.

The acidic content was 107 meq/kg and the amine group content was 32 meq/kg.

### Example 3—PFPE-Modified Polyamide Comprising 10% Wt PFPE (Mₙ=6,476, M_{w}=13,908, Polydispersity Index 2.15)

This polyamide was prepared with the following reagents:

adipic acid: 460.48 g, 3.151 mol, 6.30 eq;
MXDA: 458.3 g, 3.37 mol, 6.73 eq;
PFPE ester (E-1): 95 g, 0.051 mol, 0.102 eq;
acetic acid: 20.0 g, 0.333 mol, 0.33 eq
according to the procedure of Example 2.

The acidic content was 87 meq/kg and the amine group content was 22 meq/kg.

### Example 3A (Comparative Example)—PFPE-Modified Polyamide Comprising 10% Wt PFPE, Mₙ=22,342 and M_{w}=58,364, Polydispersity Index 2.61)

This polyamide was prepared according to the procedure of Example 1 with the following reagents:

adipic acid: 460.5 g, 3.15 mol, 6.30 eq,
MXDA: 435.8 g, 3.20 mol, 6.40 eq,
PFPE ester (E-1): 95.0 g, 0.05 mol, 0.10 eq.

The acidic content was 125 meq/kg and the amine group content was 36 meq/kg.

### Example 4—PFPE-Modified Polyamide Comprising 20% Wt PFPE (Mₙ=3,352, M_{w}=9,928, Polydispersity Index 2.96)

This polyamide was prepared according to the procedure of Example 1 with the following reagents:

adipic acid: 89.9 g, 0.61 mol, 1.23 eq
MXDA: 95.3 g, 0.70 mol, 1.4 eq
benzoic acid: 15.0 g, 0.12 mol, 0.12 eq
PFPE ester (E-1): 46.0 g, 0.02 mol, 0.05 eq.

The acidic group content was 179 meq/kg and the amine group content was 12 meq/kg.

### Example 4A (Comparative Example)—PFPE-Modified Polyamide Comprising 20% Wt PFPE (Mₙ=25,268, M_{w}=72,643, Polydispersity Index 2.87)

This polyamide was prepared according to the procedure of Example 1 with the following reagents:

adipic acid: 99.22 g, 0.678 mol, 1.36 eq;
MXDA: 95.3 g, 0.70 mol, 1.40 eq;
PFPE ester (E-1): 38.58 g, 0.021 mol, 0.040 eq.

The acidic group content was 80 meq/kg and the amine group content was 164 meq/kg.

### Example 5—Polyamide Comprising 10% Wt PFPE Units from PFPE Ester (E-2) (Mₙ=5,000, M_{w}=11,000; Polydispersity Index: 2.1)

This polyamide was prepared with the same reagents as example 1, except that PFPE ester (E-2) was used.

The acid content was 90 meq/kg, which corresponded to a conversion of the starting acidic groups of about 99%.

### Example 6—Reference Polyamide MDX6

This polyamide was prepared with the following reagents:
adipic acid: 560 g, 4.44 mol, 1 eq;
MXDA; 605 g, 4.44 mol, 1 eq
   following the procedure of Example 1.

The content of acid groups was 108 meq/kg and the content of amine groups was 25 meq/kg.

It stems from Examples 1-4 according to the invention and from comparative Examples 1A-4A that, if compound (C) is not used and the average functionality (F_{RM}) of the reaction mixture is higher than 1.96, the resulting polyamide has a molecular weight (M_{w}) higher than 20,000.

### General Procedure for the Preparation of Polyamide Blends and Molded Specimens for Tests

### Extrusion

Non fluorinated polyamide MXD6 was blended with the fluorinated polyamides of Examples 1-4 and 1A-4A by means of two extrusion cycles.

1^{st} cycle: mixing of MXD6 with the fluorinated polyamides of Examples 1-4 and 1A-4A to provide a first blend;
2^{nd} cycle: coextrusion of OCV EC_{10 983} glass fiber (4.5 mm) with the first blend (30-60% wt glass fiber with respect to the mixture). The polyamides first blends were fed to the first barrel of zone-1 of an extruder comprising of 12 zones through a loss-in-weight feeder. The barrel settings were in the range of 220-250° C. The glass fibre was fed from zone 7 through a side stuffier via a loss-in-weight feeder. The screw rate was 100 rpm. The extrudates were cooled and pelletized using conventional equipment. The glass fiber content was determined by the ashing technique disclosed in the Methods section.

For the purpose of comparison, MXD6 was blended with glass fibers only according to the coextrusion cycle 2 described above.

### Injection Molding

The extruded fluorinated polyamides were molded in a Sumitomo 75 TON injection molding machine. The temperature range was 265-280° C. The mold temperature controller was set to 140-165° C. The cooling cycle time was fixed to 35-50 sec. Under these conditions, appropriate specimens such as ISO tensile test pieces (165×10×4 mm), ISO impact bars (unnotched: 80×10×4 mm), notched: 80×8×4 mm) and color plaques (75×50×2.6 mm) were molded.

### Polyamide Blends

Polyamide blends (B-1)-(B-4), (B-1bis), (Comparative Blends (B-1a)-(B1-d) and Reference blend (BR) were prepared according to the above-described general procedure. The ingredients and the glass fiber content (GF) of each blend are reported in the table below.

TABLE 1

| | | | Amount of | Weight | PFPE (% wt | |
|---|---|---|---|---|---|---|
| | | Amount | fluorinated | ratio | with respect | |
| | | of MXD6 | polyamide | MXD6:fluorinated | to the | GF |
| Blend | Ingredients | (g) | (g) | polyamide | composition) | (% wt) |
| B_{R} | MDX6 + | 1,500 | / | / | / | 48.94 |
| | Glass fiber | | | | | |
| (B-1) | MDX6 + | 600 | 150 | 80:20 | 2 | 48.02 |
| | Glass fiber + | | | | | |
| | Polyamide | | | | | |
| | of Ex. 1 | | | | | |
| (B-1a) | MDX6 + | 900 | 100 | 90:10 | 2 | 49.00 |
| | Glass fiber + | | | | | |
| | Polyamide | | | | | |
| | of Ex. 1A | | | | | |
| (B-2a) | MDX6 + | 900 | 100 | 90:10 | 2 | 48.81 |
| | Glass fiber + | | | | | |
| | Polyamide | | | | | |
| | of Ex. 2A | | | | | |
| (B-3a) | MDX6 + | 700 | 300 | 70:30 | 3 | 48.03 |
| | Glass fiber + | | | | | |
| | Polyamide | | | | | |
| | of Ex. 3A | | | | | |
| (B-4a) | MDX6 + | 850 | 150 | 85:15 | 3 | 49.30 |
| | Glass fiber + | | | | | |
| | Polyamide | | | | | |
| | of Ex. 4A | | | | | |
| (B-2) | MDX6 + | 900 | 100 | 90:10 | 2 | 49.88 |
| | Glass fiber + | | | | | |
| | polyamide | | | | | |
| | of Ex. 2 | | | | | |
| (B-3) | MDX6 + | 840 | 360 | 70:30 | 3 | 49.39 |
| | Glass fiber + | | | | | |
| | polyamide | | | | | |
| | of Ex. 3 | | | | | |
| (B-4) | MDX6 + | 850 | 150 | 85:15 | 3 | 49.88 |
| | Glass fiber + 4 | | | | | |
| (B-2bis) | MDX6 + | 1,020 | 180 | 85:15 | 3 | 49.21 |
| | Glass fiber + | | | | | |
| | polyamide | | | | | |
| | of Ex. 2 | | | | | |

### Contact Angles of the Polyamide Blends Versus Water

Contact angles versus water of specimens obtained from the polyamide blends of the invention, from the comparative blends and from the reference blends were measured according to the procedure disclosed in the Methods section. The results are reported in the Table below.

TABLE 2

| | | Contact angle versus water | |
|---|---|---|---|
| | PFPE | | Annealed (at 120° C. |
| Example | (% wt) | Dry as molded | for 10 hours) |
| (B_{R}) | 0 | 63.2 ± 0.9 | 72.7 ± 0.4 |
| (B-1) | 2 | 85.8 ± 1.1 | 90.4 ± 0.9 |
| (B-1a) | 2 | 70.9 ± 0.5 | 81.3 ± 0.5 |
| (B-2a) | 2 | 76.6 ± 0.9 | 81.4 ± 1.3 |
| (B-3a) | 3 | 79.0 ± 1.4 | 86.5 ± 0.4 |
| (B-4a) | 3 | 80.3 ± 1.4 | 90.0 ± 0.4 |
| (B-2) | 2 | 86.4 ± 1.5 | 99.4 ± 0.4 |
| (B-3) | 3 | 86.0 ± 0.5 | 94.0 ± 1.1 |
| (B-4) | 3 | 87.4 ± 1.2 | 93.2 ± 1.0 |
| (B-2bis) | 3 | 83.3 ± 0.8 | 93.5 ± 0.6 |

The results show that the contact angles of the blends according to the invention are higher than those of reference blend BR and of the comparative blends.

### Spiral Flow Length Test

The results of the spiral flow length test are reported in the Table below for reference blend BR, (B-2) according to the invention and comparative composition (B-2a).

TABLE 3

| | PFPE | Mₙ of the fluorinated | Spiral length |
|---|---|---|---|
| Example | (% wt) | polyamide | (mm) |
| (B_{R}) | 0 | / | 25 |
| (B-2) | 2 | 7,123 | 32 |
| (B-2a) | 2 | 17,506 | 25 |

The length (distance travelled) or the weight for polyamide blend (B-2) according to the invention in the spiral mold was higher (which means better and easier flow), than that of reference blend (BR) and of comparative blend (B-2a).

### Resistance to Basic Hydrolysis

This test was carried out to show the improved resistance of polyamide of comprising PFPE segments derived from PFPE ester (E-1) (in which the ester groups are bound to the PFPE chain via a hydrogenated ether spacer) with respect to that of polyamides comprising PFPE segments derived from PFPE ester (E-2) (in which the ester groups are directly bound to the PFPE chain).

The polyamides of Examples 1 and 5 were submitted to the stability test described above. The polyamide of Example 5 underwent about 8% hydrolysis, while the polyamide of Example 1 underwent about 1% hydrolysis.

### Mechanical Tests

All molded specimens were tested as “dry as molded”. For this purpose, the specimens were stored after injection molding for at least 48 h at room temperature in a desiccator in sealed aluminium bags. The tensile properties of the materials were measured according to ISO 527 test procedure, while the notched and unnotched Izod impact strengths were measured according to the ISO 180 test procedure. The table below reports the impact strength data for unnotched and notched specimens.

TABLE 4

| | | Impact strength | |
|---|---|---|---|
| | PFPE | Unnotched IZOD | Notched IZOD |
| Blend | (% wt) | impact (kg/m²) | impact (kg/m²) |
| B_{R} | 0 | 59.6 ± 3.6 | 11.8 ± 0.4 |
| B-1 | 2 | 55.5 ± 4.6 | 13.4 ± 0.9 |
| B-1a | 2 | 60.4 ± 3.8 | 12.9 ± 0.3 |
| B-2a | 2 | 62.2 ± 4.8 | 13.2 ± 0.9 |
| B-3a | 3 | 62.3 ± 3.3 | 12.9 ± 0.5 |
| B-4a | 3 | 63.2 ± 5.3 | 13.0 ± 0.6 |
| B-2 | 2 | 65.1 ± 4.5 | 13.0 ± 0.6 |
| B-4 | 3 | 56.2 ± 1.7 | 13.4 ± 0.3 |
| B-2bis | 3 | 58.8 ± 5.9 | 13.7 ± 1.2 |

1-15. (canceled)

16. A method for making a fluorinated polyamide comprising copolymerizing a mixture comprising:
(a) a monomer (A), selected from at least one of:
(i) a mixture of:
one or more hydrogenated aliphatic, cycloaliphatic, or aromatic diamine(s) or derivative(s) thereof able to form amide groups; and
one or more hydrogenated aliphatic, cycloaliphatic, or aromatic dicarboxylic acid(s) or derivative(s) thereof able to form amide groups;
(ii) one or more aminoacid(s) or derivative(s) thereof or lactam(s);
with
(b) a monomer (B), which is at least one fully or partially fluorinated polyether mixture selected from at least one of:
a mixture of a PFPE-diamine and a PFPE monoamine or derivative(s) thereof, and
a mixture of a PFPE-dicarboxylic acid and a PFPE monocarboxylic acid or derivative(s) thereof,
and
(c) a compound (C), which is at least one hydrogenated aliphatic, cycloaliphatic, or aromatic monoamine or a derivative thereof able to form amide groups or at least one hydrogenated aliphatic, cycloaliphatic, or aromatic monocarboxylic acid or a derivative thereof able to form amide groups,
wherein the average functionality (F_{RM}) of the mixture of monomers (A), (B) and compound (C), defined as the ratio between the overall equivalents of monomers (A), (B) and compound (C) and the overall moles of monomers (A), (B) and compound (C), is lower than 1.96.

17. The method according to claim 16, wherein the average functionality (F_{RM}) ranges from 1.90 to 1.95.

18. The method according to claim 16, wherein the monomer (A) is a mixture of: the one or more hydrogenated aliphatic, cycloaliphatic, or aromatic diamine(s) or derivative(s) thereof; and the one or more hydrogenated aliphatic, cycloaliphatic, or aromatic dicarboxylic acid(s) or derivative(s) thereof.

19. The method according to claim 18, wherein the one or more diamine(s) complies with general formula (NN-I):
R—HN—R¹—NH—R′ (NN-I)
wherein:
R and R′, equal to or different from one another, are selected from hydrogen and straight or branched C₁-C₂₀ alkyl; and
R¹ is: (i) a C₂-C₃₆ straight or branched aliphatic alkylene, optionally comprising one or more divalent cycloalkyl groups or arylene groups; (ii) a divalent cycloalkyl group, or (iii) an arylene group; and
the dicarboxylic acid(s) is an aromatic dicarboxylic acid comprising two reactive carboxylic acid groups, or an aliphatic dicarboxylic acid comprising two reactive carboxylic acid groups.

20. The method according to claim 19, wherein the one or more diamine(s) of formula (NN-I) is m-xylylenediamine, and the aliphatic dicarboxylic acid is adipic acid.

21. The method according to claim 16, wherein monomer (B) is at least one fully or partially fluorinated straight or branched polyalkyleneoxy chain (R_{f}) having two chain ends, wherein one or both chain ends comprise a —COOH group or a derivative thereof able to form amide groups.

22. The method according to claim 21, wherein one or both ends of chain (R_{f}) comprise a group of formula —CF₂CH₂OCH₂COOH or a derivative thereof able to form amide groups.

23. The method according to claim 21, wherein chain (R_{f}) comprises recurring units R° having at least one catenary ether bond and at least one fluorocarbon moiety, said repeating units R°, randomly distributed along the chain, are selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW°₂O—, wherein each of W°, equal or different from each other, are F, Cl, H;
(iv) —CF₂CF₂CF₂CF₂O—;
(v) —(CF₂)ⱼ—CFZ*—O— wherein j is an integer from 0 to 3 and Z* is a group of general formula —OR_{f}*T°, wherein R_{f}* is a fluoropolyoxyalkene chain comprising a number of repeating units from 0 to 10, said recurring units are selected from: —CFXO—, —CF₂CFXO—, —CF₂CF₂CF₂O—, —CF₂CF₂CF₂CF₂O—, with each X being independently F or CF₃ and T° being a C₁-C₃ perfluoroalkyl group.

24. The method according to claim 23, wherein chain (R_{f}) complies with formula (R_{f}—III):
—(CF₂CF₂O)ₐ₁(CF₂O)ₐ₂— (R_{f}—III)
wherein:
a1, and a2 are integers >0 such that the number average molecular weight is between 400 and 5,000, with the ratio a2/a1 ranging from 0.3 to 3.

25. The method according to claim 16, wherein compound (C) is a hydrogenated aliphatic, cycloaliphatic, or aromatic monocarboxylic acid.

26. The method according to claim 25, wherein the hydrogenated aliphatic, cycloaliphatic, or aromatic monocarboxylic acid is selected from acetic acid and benzoic acid.

27. A fluorinated polyamide consisting of recurring units derived from:
(a) a monomer (A), selected from at least one of:
(i) a mixture of:
one or more hydrogenated aliphatic, cycloaliphatic, or aromatic diamine(s) or derivative(s) thereof; and
one or more hydrogenated aliphatic, cycloaliphatic, or aromatic dicarboxylic acid(s) or derivative(s) thereof;
(ii) one or more aminoacid(s) or derivative(s) thereof or lactam(s);
with
(b) a monomer (B), which is at least one (per)fluoropolyether mixture selected from:
a mixture of a PFPE-diamine and a PFPE monoamine or derivative(s) thereof, and
a mixture of a PFPE-dicarboxylic acid and a PFPE monocarboxylic acid or derivative(s) thereof,
said fluorinated polyamide having:
(c) an end-capping group derived from:
a compound (C), which is at least one hydrogenated aliphatic, cycloaliphatic, or aromatic monoamine or at least one hydrogenated aliphatic, cycloaliphatic, or aromatic amine or monocarboxylic acid or a derivative thereof able to form amide groups and, optionally, from (PFPE-N) and/or (PFPE-A).

28. The fluorinated polyamide according to claim 27 comprising from 5 to 50% wt. of units deriving from monomer (B) with respect to the weight of the fluorinated polyamide.

29. A polyamide blend comprising:
a fluorinated polyamide of claim 27; and
a hydrogenated polyamide obtained by copolymerization of:
(i) one or more hydrogenated aliphatic, cycloaliphatic, or aromatic diamine(s) or derivative(s) thereof with one or more hydrogenated aliphatic, cycloaliphatic, or aromatic dicarboxylic acid(s) or derivative(s) thereof; or
(ii) one or more aminoacid(s) or lactam(s).

30. A shaped article obtained by shaping the polyamide blend of claim 29.
